(19) United States
(12) Patent Application Publication
(10) Pub. No.: US 2007/0207754 A1
(43) Pub. Date: Sep. 6, 2007

(54) Variable inductance LC resonant circuit and radio receiver using the same

(76) Inventor: Shintaro Gomi, Tokyo (JP)

Correspondence Address: Richard L. Sampson;SAMPSON & ASSOCIATES, P.C., 50 Congress Street, Boston, MA, 02109, US

(21) Appl. No.: 11/518,090

(22) Filed: Sep. 8, 2006

(30) Foreign Application Priority Data
Mar. 2, 2006 (JP) 2006-92244

(51) Int. Cl. H04B 1/18

(52) U.S. Cl. 455/193.3; 455/180.4; 455/169.2; 455/191.2

(57) ABSTRACT

The present invention provides a means for improving the sensitivity and selectivity of a car radio receiver. The variable inductance LC resonant circuit comprises: a amplifier 53 having enough high input impedance and enough low output impedance, a inductive element 51 connected a terminal to the input of said amplifier 53 and the other terminal to the output terminal of said amplifier 53, and a capacitive element 52 connected a terminal to the input terminal of said amplifier 53 and the other terminal to the ground. The proposed technique alters the parallel resonant frequency by varying an equivalent inductance 51, 53 seen from the condenser 52 side, wherein the equivalent inductance 51, 53 varies associated with the gain of said amplifier depending on the frequency control voltage from the PLL synthesizer to the terminal 54.

This application is related to application number 2006-92244, filed Mar. 2, 2006, in Japan, the disclosure of which is incorporated herein by reference and to which priority is claimed.

The present invention relates to a variable inductance LC resonant circuit, which has a wide variable frequency range operates with low voltage and is fundamental and to be improved for realizing the radio receiver with high sensitivity and selectivity.

### BACKGROUND OF THE INVENTION

First, the biggest problem for a car radio frequency bands, such as, LW (Long Wave) band and MW (Middle Wave) band commonly called AM (amplitude Modulation) band, SW (Short Wave) band, and the like is not available a tuning circuit at the front end of an antenna because of the own condition imposed on the antenna of the car radio.

The resonant circuit of the prior art comprises inductors with fixed inductances and variable capacitance diodes. The variable capacitance range of the variable capacitance diode is 25 to 500 pF at 8 volts, which corresponds to the variable frequency ratio of about 4.5. With this variable range, it is enough to cover at least the AM band of 522 to 1710 kHz.

However, a car antenna has high impedance since it is composed of very short elements compared with receiving wave length, and as the antenna must be connected to a receiver via a coaxial cable of 1 m legally, the equivalent circuit of the antenna should be illustrated in FIG. 1. In FIG. 1, a symbol 11 indicates electromotive force generated in the antenna, a symbol 12 indicates antenna resistance of 75 ohms, a symbol 13 indicates antenna capacitance of 15 pF, and a symbol 14 indicates cable capacitance of 65 pF. These values are determined internationally in order to keep compatibility between a radio receiver and a car radio antenna.

This means that, seen from the front end of the tuning circuit of receiver, totally 80 pF capacitance consisted of the antenna capacitance of 15 pF and the cable capacitance of 15 pF is added to the tuning circuit, and, equivalently, the variable capacitance range changes to 105-580 pF, which leads to the decrease in the variable capacitance ratio to at most 6. Converting this to the variable frequency ratio, it is compressed to about 2, correspondingly, the tuning circuit in the antenna stage can not cover even the AM band.

Therefore, a method is adopted in which, as shown in FIG. 2, a plurality of coils are provided, and a frequency variable range is widen by switching the coils depending on the receiving frequency. In FIG. 2, a symbol 21 indicates coils, a symbol 22 indicates variable capacitance diodes, a symbol 23 indicates a buffer resistance, a symbol 24 indicates switches, a symbol 25 indicates control signal output via switches, and a symbol 26 indicates a terminal for inputting frequency control voltage from PLL (Phase Locked Loop) synthesizer.

In a coil-switching scheme that covers the frequency bands with, for example, three tuning circuits at the front end and a local signal generator with a resonant circuit, by switching each two coils included in each circuit, totally even 8 coils are necessary, that inevitably leads to large system size.

However, as various optional systems such as cassette tape recorder, CD (Compact Disc) driver, MD (Mini disc, Trade Mark) driver, and the like are mounted on the same car radio, miniaturization is also necessary to the car receiver, and the coil switching scheme becomes useless as being inadequate to miniaturization.

As a result, the tuning circuit in the antenna stage is omitted and the RF amplifier with high input impedance directly receives signals from the antenna, which sacrifices high sensitivity and selectivity characteristics which are the most important performances for a receiver.

A typical front end of a radio receiver of the prior art is shown in FIG. 3. A block surrounded a broken line shown in FIG. 1 indicates an equivalent circuit of an antenna, a symbol 15 indicates a RF amplifier, symbols 16 and 17 indicate a tuning circuit respectively, a symbol 18 indicates a RF mixer, a symbol 19 indicates a local signal generator, a symbol 30 indicates a terminal for outputting an intermediate frequency signal, a symbol 31 indicates voltage supplied for tuning from the PLL synthesizer, and a symbol 32 indicates a choke coil with a fixed inductance which has a resonance frequency near 300 kHz together with the total 80 pF consisted of antenna capacitance of 15 pF and cable capacitance of 65 pF and is provided in order to attenuate the hum with frequencies of 50 and 60 Hz from the High voltage transmission line. Variable tuning circuits are merely provided with at the rear stage and not provided in the front stage at all. Therefore, the antenna stage is, as can be seen from FIG. 4, ineffective to reject undesired signals at all.

The loss caused by the lack of a tuning circuit in the antenna stage is estimated actually to about −20 dB, which consists of about −15 dB originated from voltage division between antenna capacitance 15 pF and distributed capacitance 65 pF of coaxial cable and the contributions from the presence of a stray capacitance between the respective coils of the choke coil for reducing the hum from high voltage transmission line, an input capacitance of RF amplifier, and the like.

The receiver of the prior art, which inevitably abort the high capability of undesired signal rejection at the antenna stage, causes cross-talk under the presence of undesired high power signals by the overload of a RF amplifier. In order to avoid the problem, for a certain type of receiver, the gain at the antenna stage is strongly suppressed by AGC (Automatic Gain Controller), which results in the occurrence of the so-called sensitivity oppression that simultaneously suppresses the desired signal.

### SUMMARY OF THE INVENTION

It is an object of the present invention to provide a variable tuning circuit with high sensitivity and selectivity and a radio receiver with the same in the antenna stage, which resolve disadvantages associated with the radio receiver of the prior art.

In accordance with the invention, a variable inductance LC resonant circuit is provided, comprising a amplifier having enough high input impedance and enough low output impedance, a inductive element connected a terminal to the input of said amplifier and the other terminal to the output terminal of said amplifier, and a capacitive element connected a terminal to the input terminal of said amplifier and the other terminal to the ground; wherein resonant frequency of said resonant circuit is variable by changing the gain of said amplifier less than +1.

In another aspect of the present invention, a radio receiver with high sensitivity and high selectivity is provided by using the variable inductance LC resonant circuit described above.

### BRIEF DESCRIPTION OF THE DRAWINGS

FIG. 1 shows an equivalent circuit of an antenna.

FIG. 2 shows a coil switching scheme of the prior art.

FIG. 3 show a typical front end of a radio receiver of the prior art.

FIG. 4 shows a typical property of an antenna stage of the prior art.

FIG. 5 shows an embodiment of a variable inductance LC resonant circuit of the present invention.

FIG. 6 shows an equivalent circuit of the variable inductance LC resonant circuit of the present invention.

FIG. 7 shows an equivalent circuit of the circuit shown in FIG. 6.

FIG. 8 shows an equivalent circuit of the resonant circuit shown in FIG. 6 with an external load.

FIG. 9 shows a feedback path of the variable inductance LC resonant circuit of the present invention.

FIG. 10 shows a Nyquist locus of the variable inductance LC resonant circuit of the present invention.

FIG. 11 shows an embodiment of a variable gain amplifier used in the variable inductance LC resonant circuit of the present invention.

FIG. 12 shows an embodiment of a pre-amplifier included in the variable gain amplifier used in the variable inductance LC resonant circuit of the present invention.

FIG. 13 shows an embodiment of a post-amplifier included in the variable gain amplifier used in the variable inductance LC resonant circuit of the present invention.

FIG. 14 shows an example of the variable range of the variable inductance LC resonant circuit of the present invention.

FIG. 15 shows the other embodiment of the variable inductance LC resonant circuit of the present invention.

FIG. 16 shows embodiments of both a tap coupling and secondary coil coupling for the use of the variable inductance LC resonant circuit of the present invention as a tuning circuit.

FIG. 17 shows an embodiment of an oscillator with the variable inductance LC resonant circuit of the present invention.

FIG. 18 shows an embodiment of sharing the pre-amplifier of the variable inductance LC resonant circuit of the present invention with a RF amplifier having AGC function.

FIG. 19 shows an embodiment of sharing the pre-amplifier of the variable inductance LC resonant circuit of the present invention with a RF mixer.

FIG. 20 shows a typical radio receiver of the prior art.

FIG. 21 shows an embodiment of a radio receiver of the present invention.

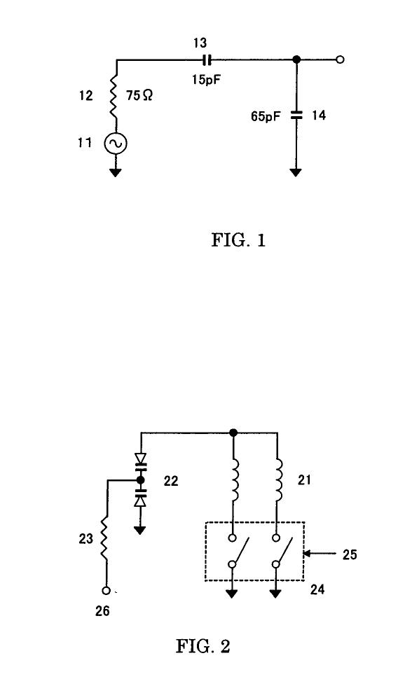

### DETAILED DESCRIPTION OF THE PREFERRED EMBODIMENTS

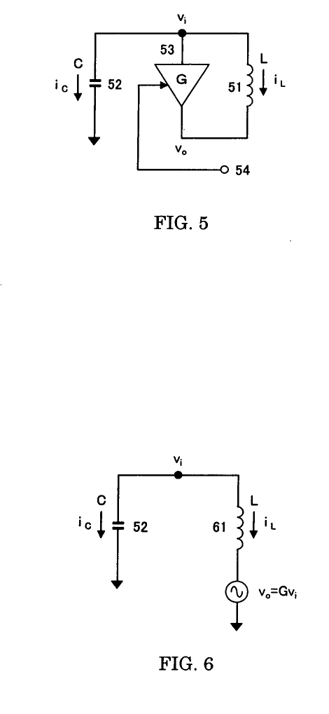

Referring now to the drawings, the embodiment of the variable inductance LC resonant circuit in accordance with the present invention is explained in detail. The principle of the variable inductance LC resonant circuit of the present invention is now explained by referring to a circuit shown FIG. 5. In FIG. 5, a symbol 51 indicates a coil with inductance L, a symbol 52 indicates a capacitor with capacitance C, a symbol 53 indicates an amplifier having enough high input impedance and enough low output impedance and gain G variable electrically in the range of less than +1, and a symbol 54 indicates frequency control signal from PLL synthesizer.

Hereat, the circuit shown in FIG. 5 becomes equivalent to the one shown in FIG. 6 in the limit of infinitely high input impedance and infinitely low output impedance of the amplifier. The principle of the variable inductance LC resonant circuit is explained which is elementally equivalent to that of the present invention. The current i_{c} flowing through the capacitor with capacitance C is expressed by Formula (1), and the current i_{L} flowing through the coil with inductance L is expressed by Formula (2);

$$\begin{matrix}{i}_{c} = jω C \cdot {v}_{i} , & ( Formula 1 ) \\ \begin{matrix}{i}_{L} = \frac{{v}_{i} - {v}_{o}}{jω L} \\ = \frac{1 - G}{jω L} \cdot {v}_{i} ,\end{matrix} & ( Formula 2 )\end{matrix}$$

where j indicates sqrt(−1), vᵢ indicates input voltage, vₒ indicates output voltage, omega. indicates angular frequency (=2×.pai.×frequency). Therefore, the admittance Yᵢₙ of the parallel resonant circuit is expressed by the following formula (3).

$$\begin{matrix}\begin{matrix}{Y}_{\text{in}} = \frac{{i}_{c} + {i}_{L}}{{v}_{i}} \\ = ( jω C \cdot {v}_{i} + \frac{1 - G}{jω L} \cdot {v}_{i} ) / {v}_{i} \\ = jω C + \frac{1 - G}{jω L} \\ = jω C + 1 / ( \frac{jω L}{1 - G} ) \\ = jω C + \frac{1}{jω {L}^{′}}\end{matrix} & ( Formula 3 )\end{matrix}$$

### Herein virtual inductance L is expressed as follows.

$${L}^{′} = \frac{L}{1 - G} \qquad ( Formula 4 )$$

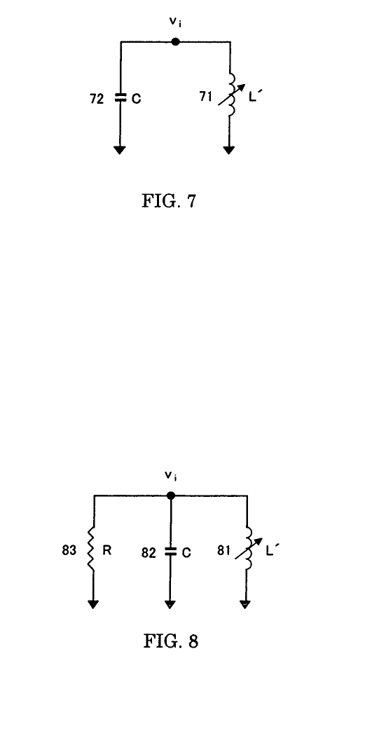

It is clear from the formula (3) that the circuit shown in FIG. 5 is a parallel resonant circuit equivalent to that shown in FIG. 7. In FIG. 7, a symbol 71 indicates a coil with inductance L′ described in the formula (4), a symbol 72 indicates a capacitor with the same capacitance marked by a symbol 52 in FIG. 5.

Furthermore, the equivalent circuit changes to that shown in FIG. 8 in case of presence of an external load and a loss resistance associated with the coil.

Defining the resonant angular frequency omeg.sub.0 by using a fixed inductance L and fixed capacitance C, the resonant angular frequency omega.sub.r of the variable inductance LC resonant circuit is expressed by formula (5), and this formula shows that the resonant angular frequency omega..sub.r is variable, in principle, from zero to infinity as the gain of an amplifier is altered from +1 to −.inf.Practically, the resonant angular frequency omega.sub.r is variable from zero to .omeg.sub.0, since the gain G is easily changeable from +1 to zero.

$$\begin{matrix}\begin{matrix}{ω}_{r} = \frac{1}{\sqrt{{L}^{′} C}} \\ = 1 / \sqrt{\frac{L}{1 - G} \cdot C} \\ = \frac{\sqrt{1 - G}}{\sqrt{LC}} \\ = {ω}_{0} \sqrt{1 - G}\end{matrix} & ( Formula 5 )\end{matrix}$$

The variable inductance LC resonant circuit of the present invention includes a feedback circuit with an amplifier. The variable inductance LC resonant circuit oscillates when the feedback path has an inadequate phase vs. amplitude performance. However, the variable inductance LC resonant circuit according to the present invention has a stable feedback path, which can be proved as described below by applying the Nyquist stable criterion.

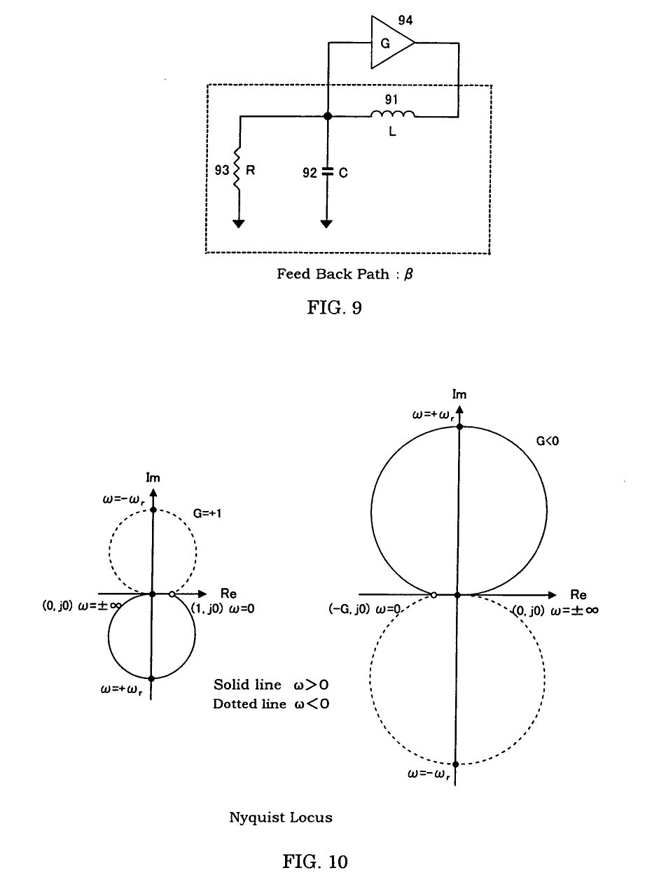

In FIG. 9, a symbol 91 indicates a coil with inductance L, a symbol 92 indicates a condenser with capacitance C, a symbol 93 indicates a load resistance R, and a symbol 94 indicates a variable gain amplifier with a gain less than +1. A feedback constant beta. of the feedback path and loop gain G.beta. are expressed by the following formulae (6) and (7).

$$\begin{matrix}\begin{matrix}β = ( 1 / ( jω C + \frac{1}{R} ) ) / ( jω L + \frac{1}{jω C + \frac{1}{R}} ) \\ = 1 / ( 1 + jω L ( jω C + \frac{1}{R} ) ) \\ = 1 / ( 1 - {ω}^{2} LC + j \frac{ω L}{R} )\end{matrix} & ( Formula 6 ) \\ G \cdot β = G / ( 1 - {ω}^{2} LC + j \frac{ω L}{R} ) & ( Formula 7 )\end{matrix}$$

### Hereat, the Nyquist locus of the loop gain G.beta. is illustrated as shown in FIG. 10. The Nyquist locus doesn't enclose the point (1, j0) inside in the range of G less than +1. Therefore, this variable inductance LC resonant circuit is stable.

Moreover, this variable inductance LC resonant circuit is possible to cover a wide frequency range even with low applied voltage. This can be proved by using an embodiment with a gain range,

0≦G<+1,

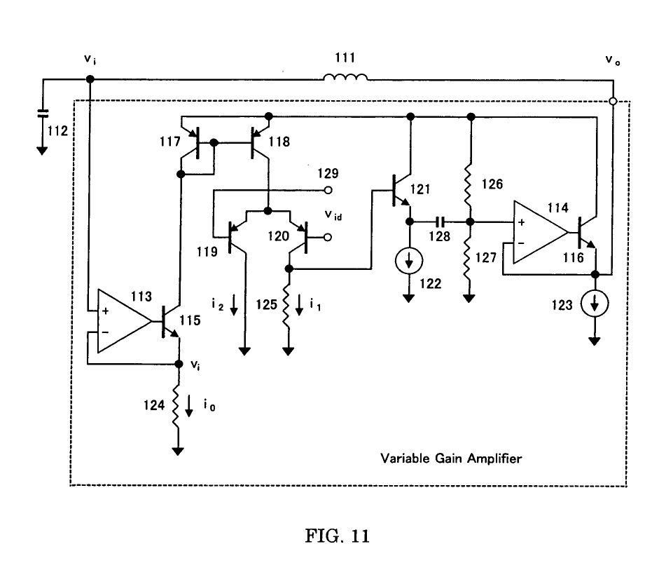

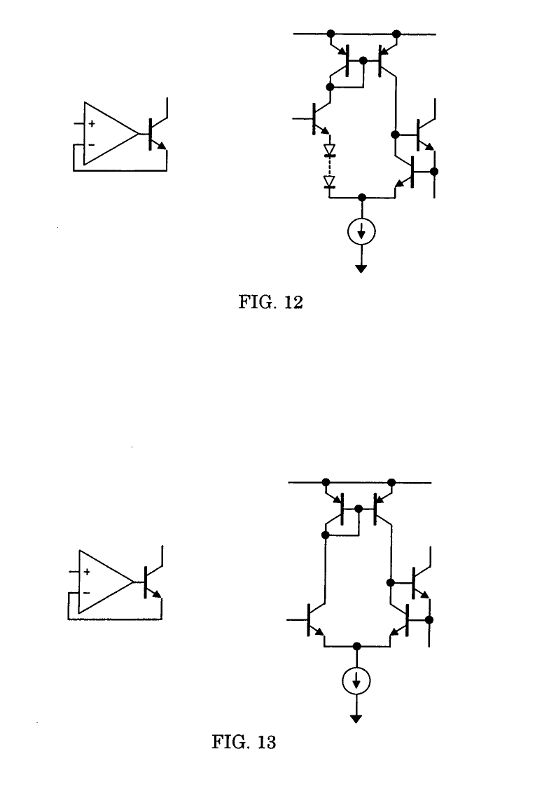

which is easy to realize by an amplifier. In FIG. 11, a symbol 111 indicates a coil with inductance L, a symbol 112 indicates a capacitor with capacitance C, a symbol 113 indicates a pre-amplifier with a gain of +1 obtained by combining with a transistor 115, a symbol 114 indicates a post-amplifier with a gain +1 by combining with a transistor 116, symbols 117 and 118 indicate a current mirror transistor respectively, symbols 119 and 120 indicate a pair of differential transistors, symbol 121 indicates a buffer transistor, symbols 122 and 123 indicate constant current source respectively, symbols 124 and 125 indicate resistors determining the gain, symbols 126 and 127 indicate bias resistances, a symbol 128 indicates a coupling condenser, and a symbol 129 indicates an input terminal for inputting gain control signal.

FIG. 12 and FIG. 13 show an embodiment of the pre-amplifier and post-amplifier respectively. In these configuration, since the input bias for the pre-amplifier is provided from the post-amplifier via the coil, level shift circuit is configured with diodes.

In FIG. 11, setting the resistances of the two resistors 122, 123 equal, it is possible to change the gain of the variable gain amplifier depending on the control signal input to the terminal 127, which enables to change the resonant frequency from omega.sub.0 to zero. This is explained with referencing to FIG. 11 and following formulae. In FIG. 11, since the signal input to+terminal of the pre-amplifier appears at the emitter of the transistor 115, denoting the resistance of the resistors 122, 123 R, following relations hold.

$$\begin{matrix}{i}_{0} = \frac{{v}_{i}}{R} & ( Formula 8 ) \\ {i}_{0} = {i}_{1} + {i}_{2} & ( Formula 9 ) \\ \frac{{i}_{1}}{{i}_{2}} = {e}^{x} \\ Here , & ( Formula 10 ) \\ x = \frac{{v}_{id}}{{v}_{T}} , & ( Formula 11 )\end{matrix}$$

vid indicates gain control voltage, v_{T} indicates thermal voltage of the device, usually 26 mV.

Since the relation of formula (12) holds, the gain G is expressed by formula (13),

$$\begin{matrix}{i}_{1} = \frac{1}{1 + {e}^{- x}} \cdot {i}_{0} , & ( Formula 12 ) \\ \begin{matrix}G = \frac{{v}_{0}}{{v}_{i}} \\ = ( {i}_{1} \cdot R ) / ( {i}_{0} \cdot R ) \\ = {i}_{1} / {i}_{0} \\ = 1 / ( 1 + {e}^{- x} )\end{matrix} , & ( Formula 13 )\end{matrix}$$

and then the relation of formula (14) holds.

$$\begin{matrix}\begin{matrix}{ω}_{r} = {ω}_{0} \sqrt{1 - G} \\ = {ω}_{0} / \sqrt{1 + {e}^{x}}\end{matrix} & ( Formula 14 )\end{matrix}$$

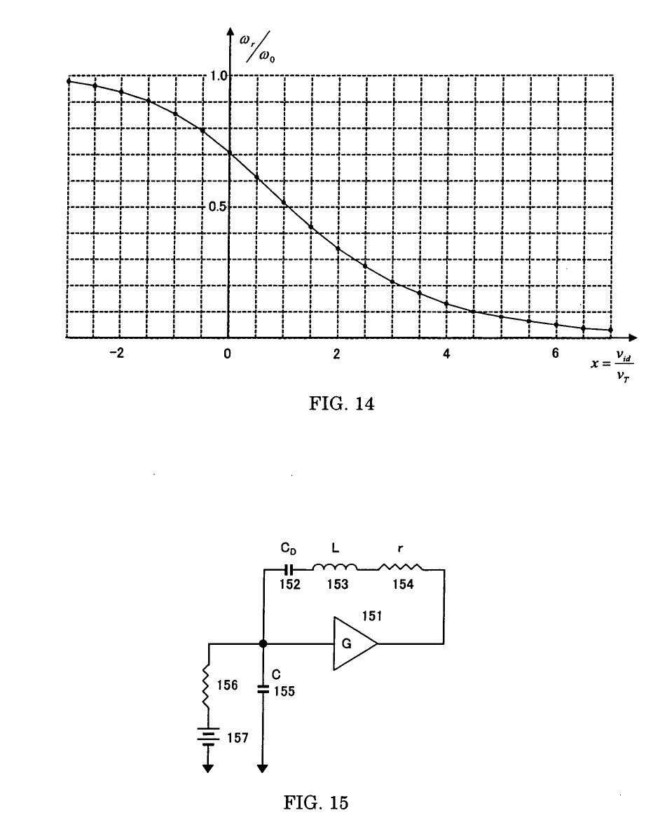

### The calculated value of .omega.sub.r/.omega.sub.0 is shown in FIG. 14. In a range of x shown in FIG. 14, since the following relation,

$$\frac{\sqrt{1 + {e}^{+ 7}}}{\sqrt{1 + {e}^{- 3}}} ≅ 32 ,$$

holds, it is possible to cover the frequency range from 150 kHz in LW band to 4.8 MHz in SW band.

### Furthermore, performing the calculation of variation ratio with more wider range,

−10≦×≦10 (Formula 15),

the relation expressed by formula (16) holds, therefore, it is possible to cover the frequency range from 150 kHz in LW band to 22.2 MHz in SW band with control voltage ranging from −260 to +260 mV.

$$\begin{matrix}\begin{matrix}\frac{\sqrt{1 + {e}^{+ 10}}}{\sqrt{1 + {e}^{- 10}}} ≅ \sqrt{{e}^{10}} \\ ≅ 148\end{matrix} & ( Formula 16 )\end{matrix}$$

FIG. 15 shows an embodiment of a pre-amplifier whose bias is set independently, where a symbol 151 indicates the same amplifier as the variable gain amplifier shown in the broken line box in FIG. 11, a symbol 152 is a coupling condenser, a symbol 153 indicates a coil, a symbol 154 indicates a loss resistance associated with coil, a symbol 155 indicates a condenser included in the resonant circuit, a symbol 156 indicates a bias resistance, and a symbol 157 indicates a DC power source. In this configuration, the impedance of the serially connected coupling condenser 152 and coil 153 is inductive in the operation frequency range. However, since the input terminal and output terminal of the amplifier 151 are electrically shorted at the serial resonance, the resistance 154 is necessary to avoid the electrical short. The quality factor Qo of the resonant circuit deteriorates in the lower bias resistance 156 regime under the unload condition, and the bias voltage becomes depending on the base current of the transistor in the higher bias resistance regime. However, when the deterioration of the unload quality factor Qo is allowable, there is a big advantage that the virtual inductance L′ is variable from zero to infinity by merely changing the gain of the amplifier 151 from zero to +1.

In addition, a conventional parallel tuning circuit comprising variable capacitors and fixed inductors has disadvantage that bandwidth becomes wider as frequency higher, narrower as frequency lower. To the contrary, the tuning circuit of the present invention comprising fixed capacitors and variable inductors has advantage that bandwidth is almost constant through the whole frequency band. In FIG. 8, a symbol 81 indicates a coil with inductance L′, a symbol 82 indicates a condenser with capacitance C, and a symbol 83 indicates a load resistor with resistance R connected the tuning circuit. Denoting the quality factor of the tuning circuit by Q, −3 dB down angular frequency bandwidth by BW, and a tuning angular frequency by .omega.sub.T, since the relation expressed by the formula (17) holds,

$$Q = \frac{R}{{ω}_{T} {L}^{′}} = {ω}_{T} CR = \frac{{ω}_{T}}{BW} , \qquad ( Formula 17 ) ,$$

the relation expressed by the formula (18) holds.

$$BW = \frac{{ω}_{T}^{2} {L}^{′}}{R} = \frac{1}{CR} \qquad ( Formula 18 )$$

As can be seen from the formula (18), although, regarding the tuning circuit of the prior art comprising variable capacitors and fixed inductors, the bandwidth increases with proportional to square of the resonant angular frequency, regarding the parallel resonant tuning circuit comprising the virtual variable inductor and fixed capacitor, the bandwidth is almost constant independent from the resonant angular frequency. This fact is very important for the radio receiver, because the capability of undesired signal rejection is invariant with respect to the every radio frequency.

Regarding the relation between the frequency alignment and the transmitter power of the AM radio service in the world metropolitan, the transmitter power is generally higher for the lower frequency stations and lower for the higher frequency stations. However, since the bandwidth of the tuning circuit with variable condensers of the prior art increases at the higher frequency band, it is not possible to adequately reduce the undesired radio wave with high transmitter power in low frequency range. The tuning circuit with the variable inductance LC resonant circuit of the present invention has a big advantage regarding the point.

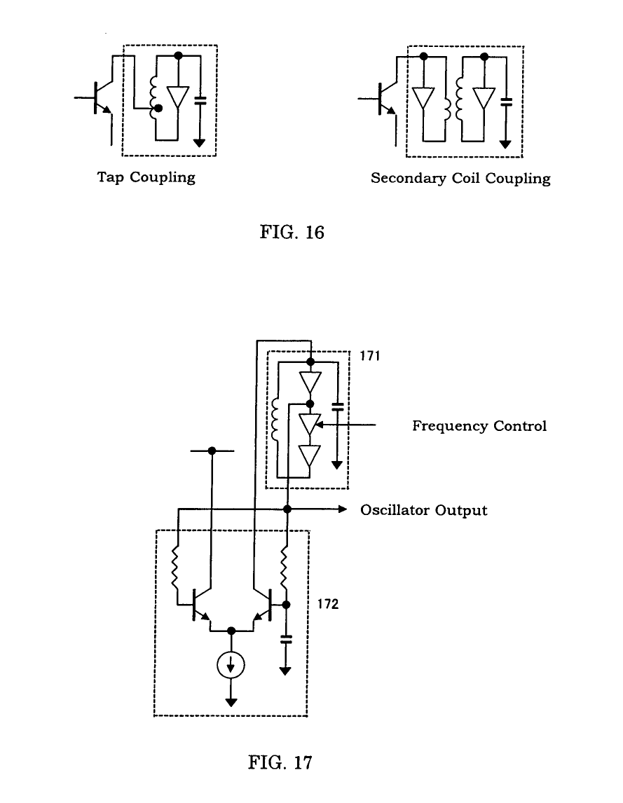

Furthermore, a tap coupling or secondary is often necessary for the LC tuning circuit. In FIG. 16, such embodiment is illustrated. Since the variable inductance resonant circuit can provide bias voltage from the output of the post-amplifier 119 of the variable gain amplifier, the output can be directly connected to a collector of the transistor.

Regarding the variable gain amplifier used in the variable inductance LC resonant circuit, in case that the input impedance of the pre-amplifier is not enough high compared to that of the condenser, the condenser is equivalent to that connected with the resistor in parallel, and in case that the output impedance of the post-amplifier is not low enough compared to that of the impedance of the coil, the coil is equivalent to that connected with the resistor in serial, and then the unload quality factor Qo of the resonant circuit is dumped, which results in the obstacle for the improvement of the sensitivity and selectivity. Therefore, it is desirable to use a negative feedback amplifier and the like.

Large non-linearity existing in the gain of the variable gain amplifier used in this resonant circuit, modulation distortion occurs in the tuning circuit under the overload caused by the receiver input. Therefore, it is necessary to use a variable gain amplifier with good linearity. In the embodiment shown in FIG. 11, the linearity is improved, since the variable gain amplifier is adopted which forms negative feedback loop including the amplifier.

FIG. 17 shows an embodiment in which the variable inductance LC resonant circuit is used in the oscillator. In FIG. 17, a symbol 171 indicates the variable inductance LC resonant circuit of the present invention shown in FIG. 11, a symbol 172 indicates a differential amplifier. The oscillator is configured by the feedback of the output of the pre-amplifier of the variable inductance LC resonant circuit 171 to the differential amplifier 172.

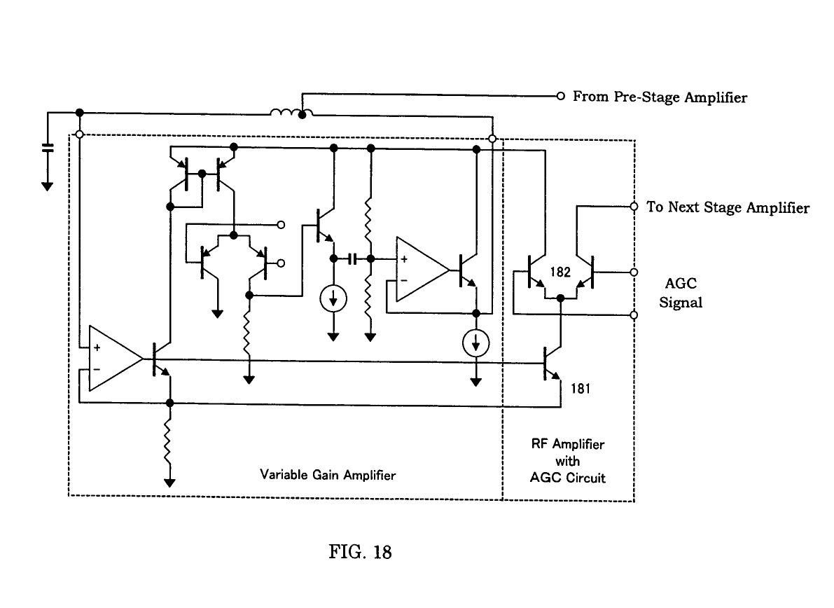

Furthermore, the pre-amplifier of the variable gain amplifier used in the variable inductance LC resonant circuit of the present invention has an advantage that the pre-amplifier can also be available as a RF amplifier with an AGC function. FIG. 18 shows the embodiment.

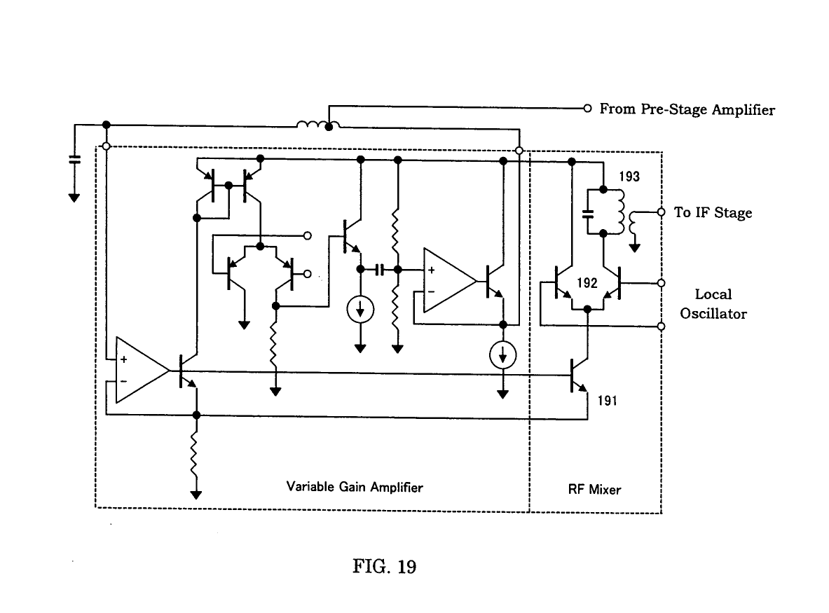

Moreover, the variable gain amplifier used in the variable inductance LC resonant circuit of the present invention has an advantage that it can also be available as a RF mixer. FIG. 19 shows the embodiment.

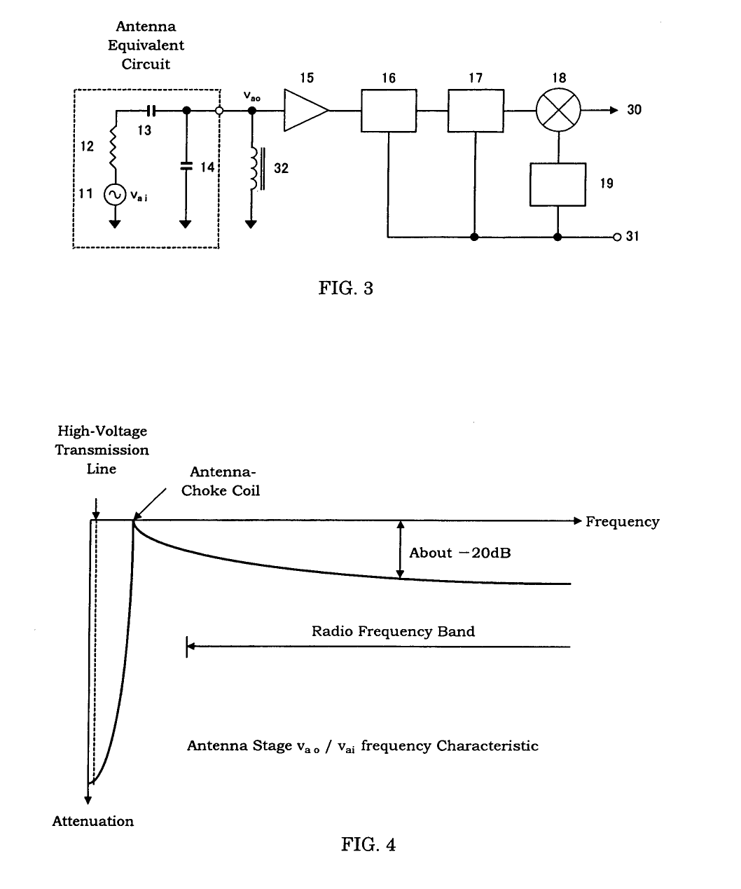

Providing a tuning circuit at the antenna stage, the desired signal can be separated from the noise or undesired signal, and then the interference can be avoided which is caused by the overload of the RF stage. Moreover, it is possible to omit the choke coil 32 shown in FIG. 3, which is necessary in the prior art to reduce the hum comes from the high voltage transmission line.

In addition, since the tuning circuit used in the resonant circuit of the present invention has an advantage of being able to vary the tuning frequency with keeping the bandwidth constant, the tuning circuit has a character that the capability of the undesired signal rejection can be kept uniform in the whole frequency band compared with that of the prior art using the variable capacitance diodes.

Although FETs with good linearity are additionally necessary for the RF amplifier of the prior art, however, since the amplifier with AGC function sharing the pre-amplifier of the variable inductance LC resonant circuit of the present invention adopts negative feedback, the amplifier with AGC function has good linearity and causes no modulation distortion for the strong undesired signals.

Also regarding the mixer, the RF mixer of negative feedback type sharing the pre-amplifier of the variable inductance LC resonant circuit of the present invention has good linearity and causes no modulation distortion for the strong undesired signals.

By adopting the variable inductance LC resonant circuit of the present invention, since a variable frequency tuning circuit can be configured by using the same variable gain amplifier in the IC tip, it is possible to omit variable capacitance diodes necessary to the prior art, a FET dedicated to the RF amplifier, the choke coil with large inductance for reducing the hum from the high voltage transmission line, and the like, and then expect to reduce the production cost.

FIG. 5 shows an embodiment of the resonant circuit of the present invention.

FIG. 11 shows an embodiment of the variable gain amplifier used in the resonant circuit of the present invention.

FIG. 15 shows the other embodiment of the variable inductance LC resonant circuit of the present invention.

FIG. 16 shows an embodiment of the variable inductance LC resonant circuit adopting the tap coupling and secondary coupling of the present invention.

FIG. 17 shows an embodiment of the differential oscillator using the resonant circuit of the present invention.

FIG. 18 shows an embodiment of sharing the pre-amplifier of the variable inductance LC resonant circuit of the present invention with a RF amplifier having AGC function. A symbol 181 indicates a transistor, and a symbol 182 indicates differential transistors for controlling the gain depending on the AGC signal.

FIG. 19 shows an embodiment of sharing the pre-amplifier of the variable inductance LC resonant circuit of the present invention with a RF mixer. A symbol 191 indicates a transistor, a symbol 192 indicates a couple of differential transistors switching according to the local oscillator signal, and a symbol 193 indicates a LC coupling circuit.

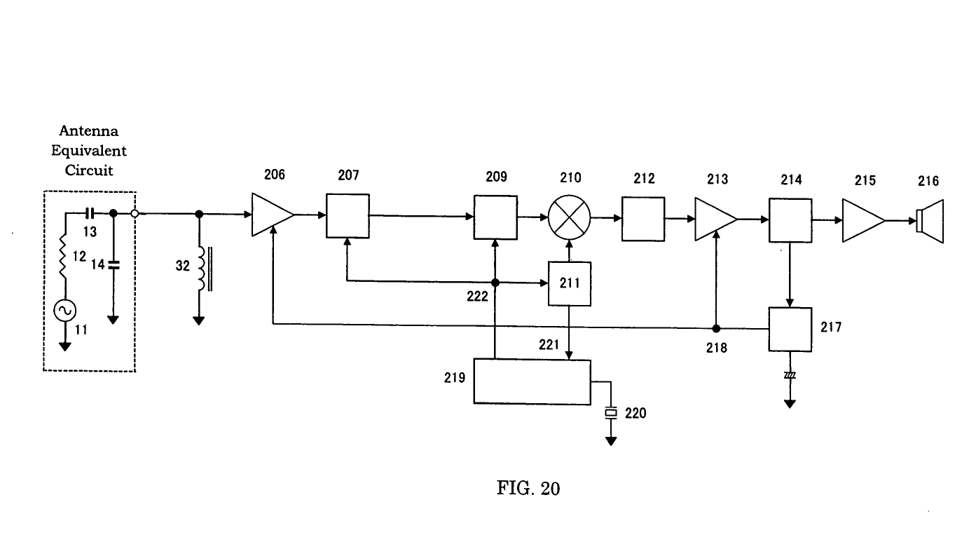

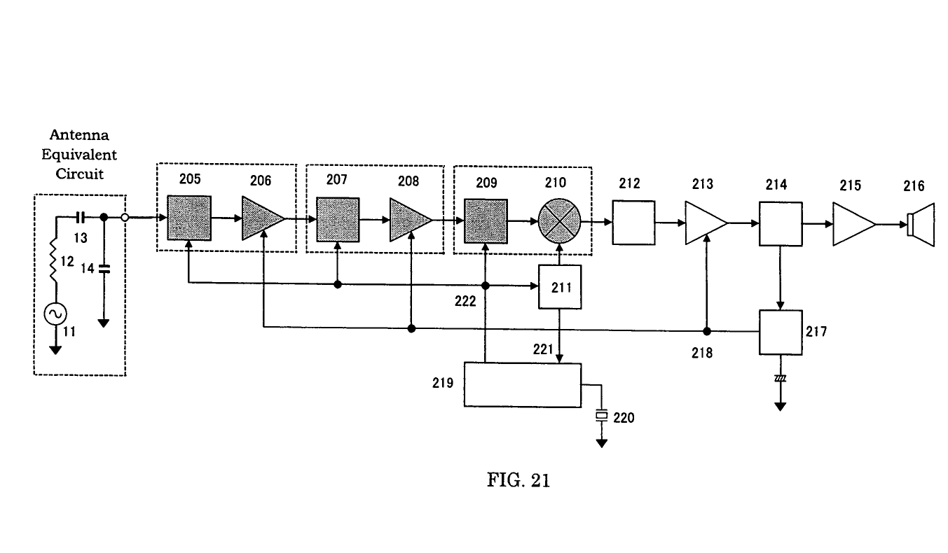

FIG. 21 shows a radio receiver using the variable inductance LC resonant circuit of the present invention, comparing with that of the prior art shown in FIG. 20.

In FIG. 20, a symbol 11 indicates electromotive force generated in the antenna, a symbol 12 indicates antenna resistance, a symbol 13 indicates antenna capacitance, a symbol 14 indicates cable capacitance, a symbol 32 indicates a choke coil for reducing the hum from the high voltage transmission line, a symbol 206 indicates a RF amplifier, symbols 207, 209 indicate a tuning circuit with a variable capacitance diode respectively, a symbol 210 indicates a RF mixer, a symbol 211 indicates a local signal generator using variable capacitance diodes, a symbol 212 indicates an IF filter, a symbol 213 indicates an IF amplifier, a symbol 214 indicates a detector, a symbol 215 indicates an audio amplifier, a symbol 216 indicates a speaker, a symbol 217 a signal generator for AGC, a symbol 218 indicates a signal line for transmitting AGC signal, a symbol 219 is a PLL circuit, a symbol 220 indicates a quartz oscillator for generating reference signal, a symbol 221 indicates a signal line for transmitting the output of the local signal generator, and a symbol 222 indicates signal lines for transmitting the voltage signal for controlling the variable capacitance diodes of the resonant circuits of both tuning circuit and the local signal generator.

In FIG. 21, symbols 205, 207, 209 indicate the tuning circuit using the variable inductance LC resonant circuit of the present invention, a symbol 206, 208 indicate a RF amplifier respectively, a symbol 210 indicates a RF mixer, and a symbol 222 indicates signal lines for transmitting the voltage signal for controlling the frequency of the resonant circuits of both tuning circuit and the local signal generator.

The four portions surrounded by the broken line shown in FIG. 21 indicate an antenna equivalent circuit 11, 12, 13, 14, two RF amplifiers 206, 208 with the tuning circuit 205, 207 shown in FIG. 18 each, and a RF mixer 210 with a tuning circuit 209 shown in FIG. 19, respectively.

What is claimed is:

1. A variable inductance LC resonant circuit comprising:
a amplifier having enough high input impedance and enough low output impedance, a inductive element connected a terminal to the input of said amplifier and the other terminal to the output terminal of said amplifier, and a capacitive element connected a terminal to the input terminal of said amplifier and the other terminal to the ground;
wherein resonant frequency of said resonant circuit is variable by changing the gain of said amplifier less than +1.

2. A radio receiver using the variable inductance LC resonant circuit of claim 1.
